(19) United States
(12) Patent Application Publication
(10) Pub. No.: US 2006/0132683 A1
(43) Pub. Date: Jun. 22, 2006

(54) Array substrate with reduced flicker, display panel having the same, and display device having the same

(76) Inventors: Young-Nam Yun, Gunpo-si (KR); Yong-Han Park, Suwon-si (KR); Maung-Hi Lee, Suwon-si (KR)

Correspondence Address: DLA PIPER RUDNICK GRAY CARY US, LLP, 2000 UNIVERSITY AVENUE, E. PALO ALTO, CA, 94303-2248, US

(21) Appl. No.: 11/240,588

(22) Filed: Sep. 29, 2005

(30) Foreign Application Priority Data
Oct. 1, 2004 (KR) 10-2004-0078259

(51) Int. Cl. G02F 1/1335

(52) U.S. Cl. 349/114

(57) ABSTRACT

An array substrate has a first pixel unit and a second pixel unit adjacent to the first pixel unit. The first pixel unit has a first reflective area for reflecting a first light and a first transmission area for transmitting a second light and the second pixel unit has a second reflective area for reflecting the first light and a second transmission area for transmitting the second light, wherein the second reflective area has a size different from a size of the first reflective area and the second transmission area has a size different from a size of the first transmission area. A size ratio between the first reflective area and the first transmission area is different from a size ratio between the second reflective area and the second transmission area. Therefore, the flicker generated with an inversion drive method may be reduced.

### CLAIM FOR PRIORITY

This application claims priority under 35 USC § 119 to Korean Patent Application No. 2004-78259 filed on Oct. 1, 2004, the content of which is herein incorporated by reference in its entirety for all purposes.

### BACKGROUND OF THE INVENTION

1. Field of the Invention

The present invention relates generally to an array substrate, a display panel and a display device having the array substrate. More particularly, the invention relates to an array substrate for reducing flicker, and a display panel and a display device having the array substrate.

2. Description of the Related Art

Generally, display devices can be divided into a transmissive type, a reflective type, and a transflective type that includes both a transmissive section and a reflective section. While the strength of the transmissive-type display device is that it shows high-quality images regardless of the surrounding conditions, the strength of the reflective-type display device is that it does not consume as much power as the transmissive-type device. The transflective-type display device, which is a combination of the transmissive-type and the reflective-type devices, is used to display an image in high quality and reduce power consumption. The transflective-type display devices use different gamma curves depending on whether it is operating in a transmissive mode or a reflective mode, thereby enhancing the display quality and reducing power consumption.

However, the transflective-type display device has some disadvantages. For example, a flicker may be generated by an effective voltage difference between adjacent lines when an inversion drive method is used to drive the liquid crystal display device. When a line inversion method is used, voltages having opposite polarities are applied to two adjacent row lines so that the flicker having a horizontal stripe pattern may be generated by the effective voltage difference between the two row lines. Similarly, when a column inversion method is used, the flicker having a vertical stripe pattern may be generated by the effective voltage difference between two adjacent columns where voltages having opposite polarities are applied.

### SUMMARY OF THE INVENTION

Accordingly, the present invention is provided to substantially obviate one or more problems due to limitations and disadvantages of the related art.

Exemplary embodiments of the present invention provide an array substrate having scan lines extending in a first direction, data lines extending in a second direction that is substantially perpendicular to the first direction, and pixel units defined by the scan lines and data lines. Each of the pixel units has a reflective area and a transmission area. In some embodiments of the present invention, the array substrate includes a first pixel unit and a second pixel unit adjacent to the first pixel unit. The first pixel unit has a first reflective area for reflecting a first light and a first transmission area for transmitting a second light. The second pixel unit has a second reflective area for reflecting the first light and a second transmission area for transmitting the second light, wherein the second reflective area has a size different from the size of the first reflective area and the second transmission area has a size different from the size of the first transmission area. For example, a size ratio between the first reflective area and the first transmission area is different from a size ratio between the second reflective area and the second transmission area. In addition, a size ratio between an entire reflective area of the array substrate and an entire transmission area is substantially identical to a size ratio between the sum of the first and second reflective areas and the sum of first and second transmission areas.

Exemplary embodiments of the present invention may also provide a display panel. In some embodiments of the present invention, the display panel includes a first substrate, a second substrate and a liquid crystal layer. The first substrate has a first pixel unit and a second pixel unit adjacent to the first pixel unit. The first and second pixel units have first and second reflective areas and first and second transmission areas, respectively. The second reflective area has a size different from the size of the first reflective area and the second transmission area has a size different from the size of the first transmission area. The second substrate is combined with the first substrate to receive the liquid crystal layer. For example, a first cell gap of the liquid crystal layer corresponding to the first reflective area is different from a second cell gap of the liquid crystal layer corresponding to the first transmission area and a third cell gap of the liquid crystal layer corresponding to the second reflective area is different from a fourth cell gap of the liquid crystal layer corresponding to the second transmission area.

Exemplary embodiments of the present invention may also provide a display device. In some embodiments of the present invention, the display device includes a display unit and a driver unit. The display unit includes a plurality of pixel units, each of which has a reflective area and a transmission area, wherein two adjacent pixels are different in a size ratio between the reflective area and the transmission area and, wherein a size ratio between the sum of the reflective areas of the adjacent two pixels and the sum of the transmission areas is substantially identical to a size ratio between an entire reflective area of the display unit and an entire transmission area. The driver unit provides the display unit with a driving signal for driving the pixels. The display unit further includes a first pixel unit, a second pixel unit adjacent to the first pixel unit in a first direction and a third pixel unit adjacent to the first pixel unit in a second direction. For example, the display unit includes a first pixel unit, a second pixel unit adjacent to the first pixel unit in a first direction and a third pixel unit adjacent to the first pixel unit in a second direction. When the driver provides first and second pixel units with a data signal having a first polarity and provides the third pixel unit with the data signal having a second polarity, an amount of a light exiting the first pixel unit is greater (or smaller) than an amount of light exiting the second pixel unit. When the driver provides the first and third pixel units with a data signal having a first polarity and provides the second pixel unit with the data signal having a second polarity, an amount of the light exiting from the first pixel unit is greater (or smaller) than an amount of light exiting from the third pixel unit.

According to the present invention, a flicker having a horizontal stripe pattern may be reduced when a line inversion drive method is used and the flicker having a vertical stripe pattern may be reduced when a column inversion drive method is used.

### BRIEF DESCRIPTION OF THE DRAWINGS

The above and other advantages of the present invention will become readily apparent by reference to the following detailed description when considered in conjunction with the accompanying drawings wherein:

FIG. 1 is a plan view illustrating a part of an array substrate according to an exemplary embodiment of the present invention;

FIG. 2 is a cross sectional view of a liquid crystal display panel taken along the line I-I′ in FIG. 1;

FIG. 3 is a block diagram illustrating a liquid crystal display device having the array substrate in FIG. 1;

FIGS. 4A through 4D are waveform diagrams illustrating a line inversion scheme of the liquid crystal display device in FIG. 3;

FIG. 5 is a schematic view illustrating a line inversion scheme of the liquid crystal display device in FIG. 3;

FIG. 6 shows a luminescent characteristic of the liquid crystal display device in FIG. 5 when operating in a transmission mode;

FIG. 7 shows a luminescent characteristic of the liquid crystal display device in FIG. 5 when operating in a reflective mode;

FIG. 8 is a schematic view illustrating a column inversion scheme of the liquid crystal display device in FIG. 3;

FIG. 9 shows a luminescent characteristic of the liquid crystal display device in FIG. 8 when operating in a transmission mode;

FIG. 10 shows a luminescent characteristic of the liquid crystal display device in FIG. 8 when operating in a reflective mode;

FIG. 11 is a plan view illustrating a part of an array substrate according to another exemplary embodiment of the present invention;

FIG. 12 is a schematic view illustrating a line inversion scheme adopted for a liquid crystal display device having the array substrate in FIG. 11;

FIG. 13 shows a luminescent characteristic of the liquid crystal display device in FIG. 12 when operating in a transmission mode;

FIG. 14 is a schematic view illustrating a column inversion scheme adopted for a liquid crystal display device having the array substrate in FIG. 11; and

FIG. 15 shows a luminescent characteristic of the liquid crystal display device in FIG. 14 when operating in a transmission mode.

### DESCRIPTION OF THE EXEMPLARY EMBODIMENTS

Hereinafter, the present invention will be explained in detail with reference to the accompanying drawings.

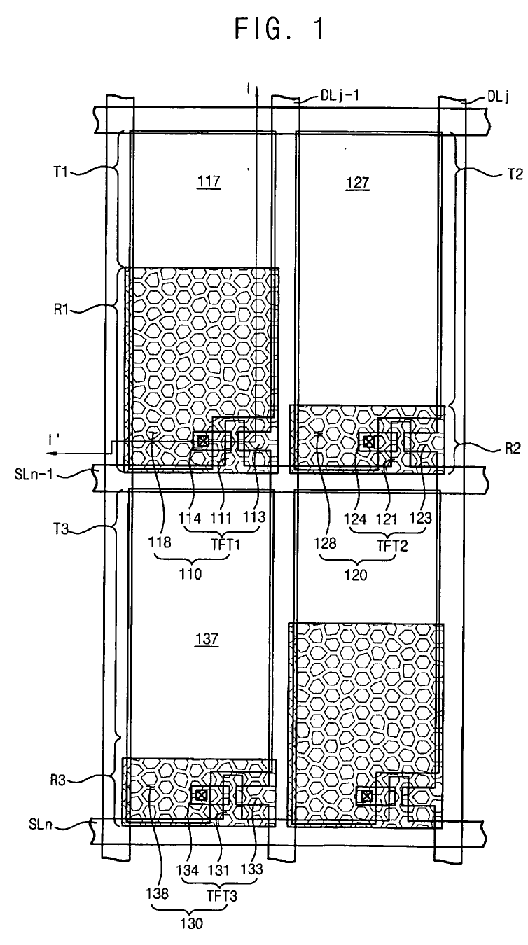

FIG. 1 is a plan view illustrating a part of an array substrate according to an exemplary embodiment of the present invention.

Referring to FIG. 1, the array substrate includes n×m pixels defined by n scan lines and m data lines. Particularly, the array substrate includes a first pixel 110, a second pixel 120 aligned with the first pixel 110 in a first direction and a third pixel 130 aligned with the first pixel 110 in a second direction 130.

The first pixel 110 includes a first switching element TFT1, a first storage capacitor (not shown), and a first pixel electrode 117 that is electrically coupled to one end of a first liquid crystal capacitor (not shown).

The first switching element TFT1 has a first gate electrode 111 coupled to a first scan line SLn-1 that extends in the first direction, a first source electrode 113 coupled to a first data line DLj-1, and a first drain electrode 114 coupled to the first pixel electrode 117. The first storage capacitor (not shown) has a first end electrically coupled to a first electrode (not shown) formed together with the first gate electrode 111 on a same layer and a second end electrically coupled to the first pixel electrode 117. The storage capacitor may have the first electrode formed along an edge portion of the first pixel 117 to increase the aperture ratio. The storage capacitors in the respective pixels are electrically coupled to one another.

The first pixel electrode 117 has a first reflective area R1 where a reflective plate 118 for reflecting a first light is positioned and a first transmission area T1 for transmitting a second light. The “first light,” as used herein, includes light in the environment such as natural light, frontlight, etc., and the “second light” includes light from a backlight assembly that forms part of the display device. For simplicity of illustration, the description assumes that the “first light” is natural light although it is not so limited.

The second pixel 120 is adjacent to the first pixel in the first direction. The second pixel 120 includes a second switching element TFT2, a second storage capacitor (not shown) and a second pixel electrode 127 that is electrically coupled to one end of a second liquid crystal capacitor (not shown). The second switching element TFT2 has a second gate electrode 121 coupled to the first scan line SLn-1, a second source electrode 123 coupled to a second data line DLj adjacent to the first data line DLj-1 and a second drain electrode 124 coupled to the second pixel electrode 127. The second storage capacitor (not shown) has a first end electrically coupled to a first electrode (not shown) formed together with the second gate electrode 121 on a same layer and a second end electrically coupled to the second pixel electrode 127. The second pixel electrode 127 has a second reflective area R2 where a reflective plate 128 for reflecting the first light is formed and a second transmission area T2 for transmitting a second light.

A size ratio (R1:T1) between the first reflective area R1 and the first transmission area T1 is different from a size ratio (R2:T2) between the second reflective area R2 and the second transmission area T2 (i.e., R1:T1≠R2:T2). However, a size ratio (R1+R2:T1+T2) between over the sum of the first and second reflective areas R1 and R2 and over the sum of the first and second transmission areas T1 and T2 is equal to a size ratio (ER:ET) between an entire reflective area ER of the array substrate and an entire transmission area ET (i.e., R1+R2:T1+T2=ER:ET).

The third pixel 130 is adjacent to the first pixel 110. The third pixel 130 includes a third switching element TFT3, a third storage capacitor (not shown) and a third pixel electrode 137 that is electrically coupled to one end of a third liquid crystal capacitor (not shown).

The third switching element TFT3 has a third gate electrode 131 coupled to a second scan line SLn, a third source electrode 133 coupled to the first data line DLj-1 and a third drain electrode 134 coupled to the third pixel electrode 137. The third storage capacitor (not shown) has a first end electrically coupled to a first electrode (not shown) formed together with the third gate electrode 131 on a same layer and a second end electrically coupled to the third pixel electrode 137. The third pixel electrode 137 has a third reflective area R3 where a reflective plate 138 for reflecting the first light is positioned and a third transmission area T3 for transmitting a third light.

The size ratio (R1:T1) between the first reflective area R1 and the first transmission area T1 is different from a size ratio (R3:T3) between the third reflective area R3 and the third transmission area T3 (i.e., R1:T1≠R3:T3). However, a size ratio (R1+R3:T1+T3) between the sum of the first and third reflective areas R1 and R3 and the sum of the first and third transmission areas T1 and T3 is equal to the size ratio (ER:ET) between the entire reflective area ER of the array substrate and the entire transmission area ET (i.e., R1+R3:T1+T3=ER:ET).

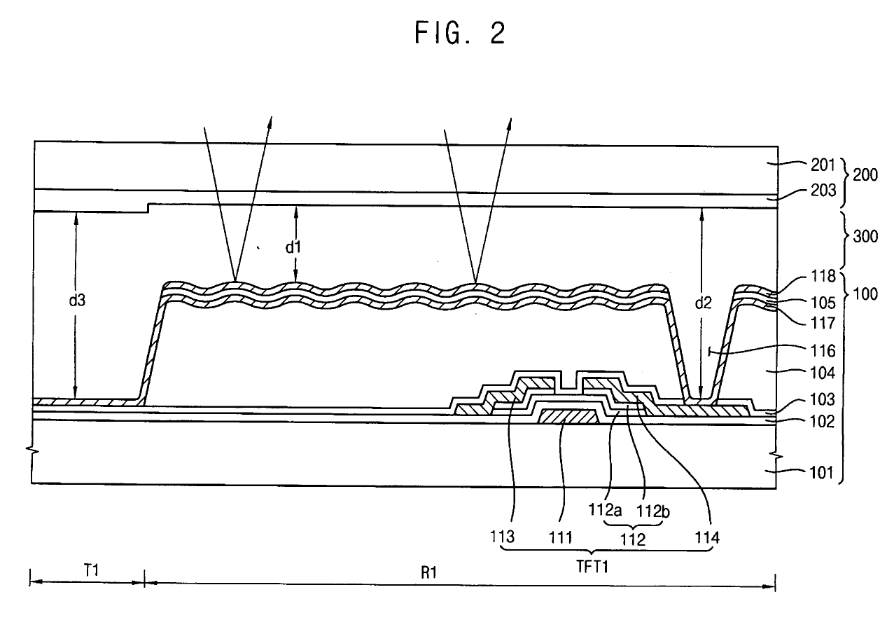

FIG. 2 is a cross sectional view of a liquid crystal display panel taken along the line I-I′ in FIG. 1.

Referring to FIGS. 1 and 2, the liquid crystal display panel has an array substrate 100, a color filter substrate 200 and a liquid crystal layer 300 positioned between the array substrate 100 and the color filter substrate 200.

The array substrate 100 includes a gate metal layer formed on a transparent substrate 101 to form a scan line SL extending in a first direction and a gate electrode 111 of the switching element TFT. A channel layer 112 is formed on the gate electrode 111. The channel layer 112 includes an activation layer 112a and a resistive contact layer 112b.

The array substrate 100 includes source and drain metal layers to form a data line DL extending in a second direction and source and drain electrodes 113 and 114 of the switching element TFT. A first passivation layer 103 and an insulation layer 104 are formed on the source and drain metal layers. The insulation layer 104 is patterned to form a reflective area R1 and a transmission area T1 of the pixel. More specifically, the insulation layer 104 in the transmission area T1 is etched to leave the insulation layer 104 in the reflective area R1. In addition, a contact hole 116 is formed on a portion of the insulation layer 104. A surface of the insulation layer 104 in the reflective area R1 may be patterned in a concavo-convex pattern to increase the reflectivity of light incident thereon.

The array substrate 100 has a transparent electrode layer to form the pixel electrode 117 that is coupled to the drain electrode 114 via the contact hole 116. A protective layer 105 is formed on the reflective area R1 of the pixel electrode 117. The reflective plate 118 is formed on the protective layer 105. Namely, the reflective plate 118 is formed above the reflective area R1 of the pixel electrode 117.

The pixel electrode 117 is a transparent electrode capable of transmitting light. A metal oxide such as indium tin oxide (ITO), tin oxide (TO), indium zinc oxide (IZO), etc., may be used for the pixel electrode 117.

The color filter substrate 200 includes a transparent substrate 201 on which a black matrix layer (not shown) that defines the pixel area is formed. A color pixel layer 203 is formed on the pixel area defined by the black matrix layer. A second passivation layer (not shown) for protection and planarization is formed on the black matrix layer and the color pixel layer 203. A common electrode layer (not shown) is formed on the second passivation layer.

The liquid crystal layer 300 is positioned between the array substrate 100 and the color filter substrate 200. The light transmittance through the liquid crystal layer 300 varies according to a voltage difference between a supply voltage applied to the pixel electrode 117 of the array substrate and a supply voltage applied to the common electrode layer (not shown) of the color filter substrate 200.

A cell gap d1 (i.e., a thickness of the liquid crystal layer 300) in the reflective area R1, a cell gap d2 in an area where the contact hole 116 is formed and a cell gap d3 in the transmission area T1 are all different from one another. The cell gaps d1, d2 and d3 may have a relationship such that d1<d2<d3.

Particularly, when a refractive index anisotropy of liquid crystal molecules of the liquid crystal layer 300 is designated as Δn, a liquid crystal cell at the reflective area R1 has the refractive characteristic of Δnd1, a liquid crystal cell at the contact hole 116 has the refractive index characteristic of Δnd2 and the liquid crystal cell at the transmission area T1 has the refractive index characteristic of Δnd3.

The cell gaps in the reflective area R1 and the transmission area T1 have optimal spacing that is varied depending on a condition of an optical film positioned at upper and lower portions and both side portions of the liquid crystal layer 300. However, the cell gap d1 in the reflective area R1 is smaller than the cell gap d3 in the transmission area T1. For example, the cell gap d1 in the reflective area R1 is one half of the cell gap d3 in the transmission area T1.

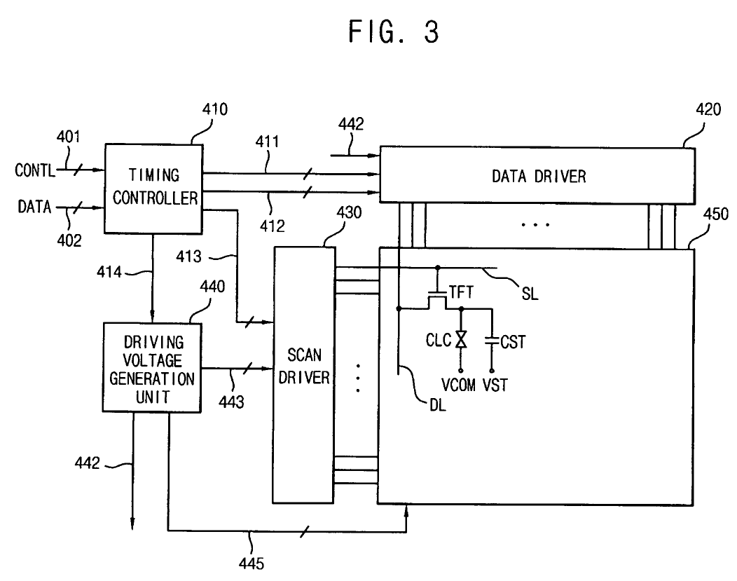

FIG. 3 is a block diagram illustrating a liquid crystal display device having the array substrate in FIG. 1.

Referring to FIG. 3, the liquid crystal display device includes a timing controller 410, a data driver 420, a scan driver 430, a driving voltage generation unit 440 and a liquid crystal panel 450.

The timing controller 410 generates second, third and fourth control signals 412, 413 and 414 based on a first control signal (CONTL) 401 received from an external source to control the liquid crystal display device. Particularly, the first control signal 401 may include a main clock signal MCLK, a horizontal synchronization signal HSYNC, a data enable signal DE and a vertical synchronization signal VSYNC. The second control signal 412 may include a horizontal synchronization start signal STH, an inversion signal RVS and a load signal TP to control the data driver 420. The third control signal 413 may include a scan start signal STV, a clock signal CK and an output enable signal OE to control the scan driver 430. The fourth control signal 414 may include the main clock signal MCLK and the inversion signal RVS to control the driving voltage generation unit 440.

The data driver 420 performs signal processing on a data signal 411 based on the second control signal and outputs the processed signal to the liquid crystal panel 450. Particularly, the timing controller 410 receives a data signal (DATA) 402 from the external source and provides the data driver 420 with the data signal 402 in a frame unit as the data signal 411 based on the data enable signal DE. The data driver 420 converts the data signal 411 into a gray scale voltage and outputs the gray scale voltage to a plurality of data lines of the liquid crystal panel 450. The gray scale voltage may have a first polarity and a second polarity opposite the first polarity, according to an inversion method of the liquid crystal display device.

When a line inversion method is used, pixels coupled to a first scan line of the liquid crystal panel 450 are charged to a voltage having the first polarity and pixels coupled to a second scan line are charged to a voltage having the second polarity. The second scan line is the scan line next to the first scan line. This way, the polarities of pixel voltages are alternated line by line such that every other scan line has the same polarity.

In a column inversion method, pixels coupled to a first data line of the liquid crystal panel 450 are charged to a voltage having the first polarity and pixels coupled to a second data line are charged to a voltage having the second polarity. The second data line neighbors the first data line. This way, the polarities of the pixel voltages are alternated line by line such that every other data line has the same polarity.

The scan driver 430 generates a plurality of scan signals based on the third control signal 413 to output the scan signals to the liquid crystal panel 450.

The driving voltage generation unit 440 generates scan voltages (VON and VOFF) 433, common voltages (VCOM, VST) 445 and a reference gray scale voltage (VREF) 442, etc., based on the fourth control signal 414. The scan voltages (VON and VOFF) 433 are provided to the scan driver 430 and the common voltages (VCOM, VST) 445 are provided to a liquid crystal capacitor CLC and a storage capacitor CST of the liquid crystal panel 450. The reference gray scale voltage (VREF) 442 is provided to the data driver 420.

The liquid crystal panel 450 has a plurality of data lines DL, a plurality of scan lines SL substantially perpendicular to the data lines DL and a plurality of pixel areas defined by the data lines and scan lines. In the pixel area, a switching element TFT, the liquid crystal capacitor CLC and the storage capacitor CST are formed.

The liquid crystal panel 450 is a transflective panel that has a reflective area ER and a transmission area ET. Namely, each of the pixels has a reflective area R and a transmission area T. A size ratio (R1:T1) between the reflective area R1 and the transmission area T1 of a first pixel of the liquid crystal panel 450 is different from a size ratio (R2:T2) between the reflective area R2 and the transmission area T2 of a second pixel next to the first pixel (i.e., R1:T1≠R2:T2). However, a size ratio (R1+R2:T1+T2) between the sum of the first and second reflective areas R1 and R2 and the sum of the first and second transmission areas T1 and T2 is equal to a size ratio (ER:ET) between an entire reflective area ER of the liquid crystal panel 450 and an entire transmission area ET (i.e., R1+R2:T1+T2=ER:ET)

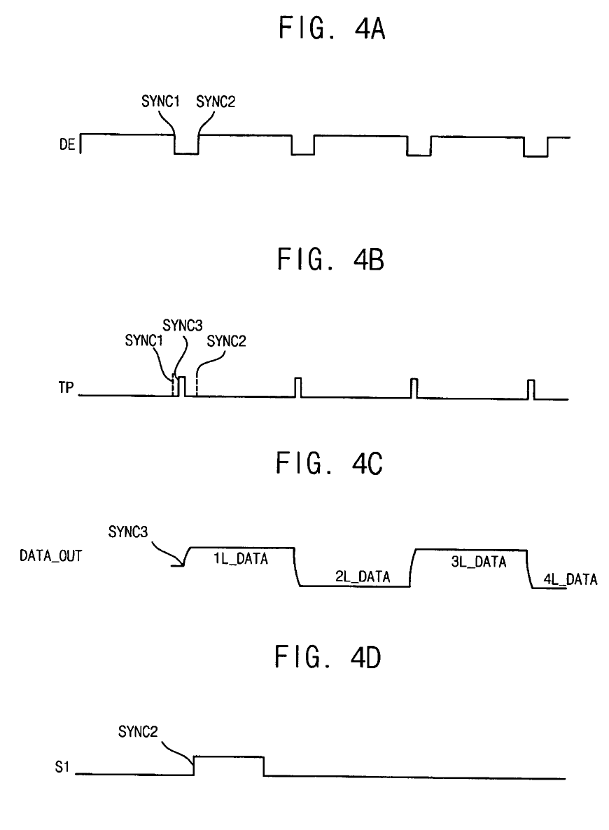

FIGS. 4A through 4D are waveform diagrams illustrating a line inversion scheme of the liquid crystal display device in FIG. 3.

Referring to FIGS. 3 through 4D, the timing controller 410 receives a data signal (DATA) 402 from the external source and provides the data signal 402 in a frame unit to the data driver 420 as the data signal 411 based on the data enable signal DE. The data driver 420 converts the data signal 402 into the gray scale voltage to output the gray scale voltage to the plurality of data lines of the liquid crystal panel 450. The gray scale voltage corresponding to a first data 1L_DATA may have a first polarity and the gray scale voltage corresponding to a second data 2L_DATA may have a second polarity. For example, the first polarity may correspond to a positive polarity (+) and the second polarity may correspond to a negative polarity (−).

When the first data 1L_DATA is outputted to the liquid crystal panel 450, the scan driver 430 outputs a first scan signal S1 to a first scan line to activate the pixels of the liquid crystal panel 450.

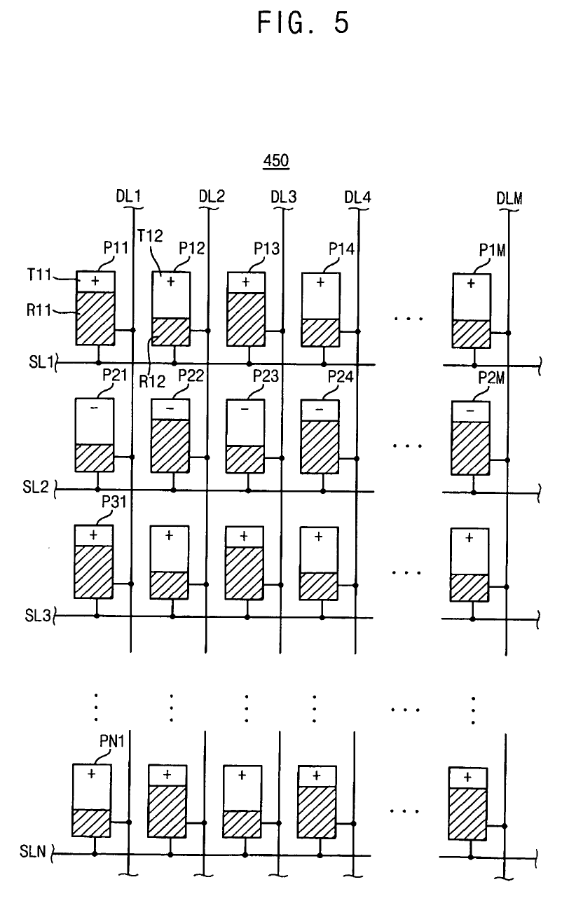

FIG. 5 is a schematic view illustrating a line inversion scheme of the liquid crystal display device in FIG. 3.

Referring to FIG. 5, pixels P11, P12, . . . , P1M coupled to a first scan line SL1 of the liquid crystal panel 450 are charged to the voltage having a first polarity (e.g., (+)) and pixels P21, P22, . . . , P2M coupled to a second scan line SL2 next to the first scan line SL1 are charged to the voltage having a second polarity (e.g., (−)). Similarly, other pixels coupled to the respective scan lines of the liquid crystal panel 450 are charged to voltages of opposite polarities in an alternating manner.

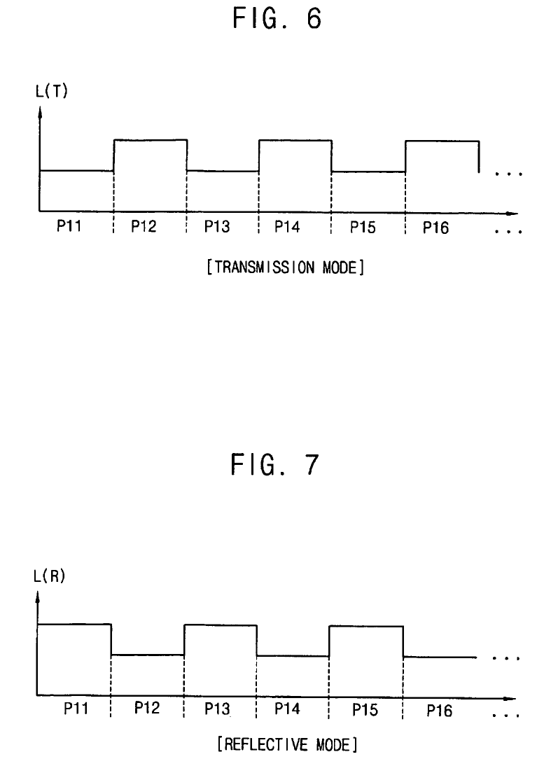

FIG. 6 shows a luminescent characteristic of the liquid crystal display device in FIG. 5 when operating in transmission mode.

Referring to FIGS. 5 and 6, a size ratio (R11:T11) between a first reflective area R11 and a first transmission area T11 of a first pixels P11 is different from a size ratio (R12:T12) between a second reflective area R12 and a second transmission area T12 of a second pixel P12 that is adjacent to the first pixel P11 in a row direction (i.e., R11:T11≠R12:T12). For example, the first transmission area T11 is smaller than the second transmission area T12.

Therefore, the amount of light transmitted through the first pixel P11 is less than the amount of light transmitted through the second pixel P12. The amounts of light transmitted through the first pixel P11 and the second pixel P12 are proportional to the size ratio between the first and second transmission areas T11 and T12. The luminescent characteristic of the first and second pixels P11 and P12 adjacent to each other along the scan line may visually appear to be operating under a dot inversion method. A dot inversion driving technique involves applying data voltages to the pixel electrode such that the polarities of two pixel electrodes of adjacent column lines or adjacent row lines are opposite to each other. Using the dot inversion, flicker may be reduced.

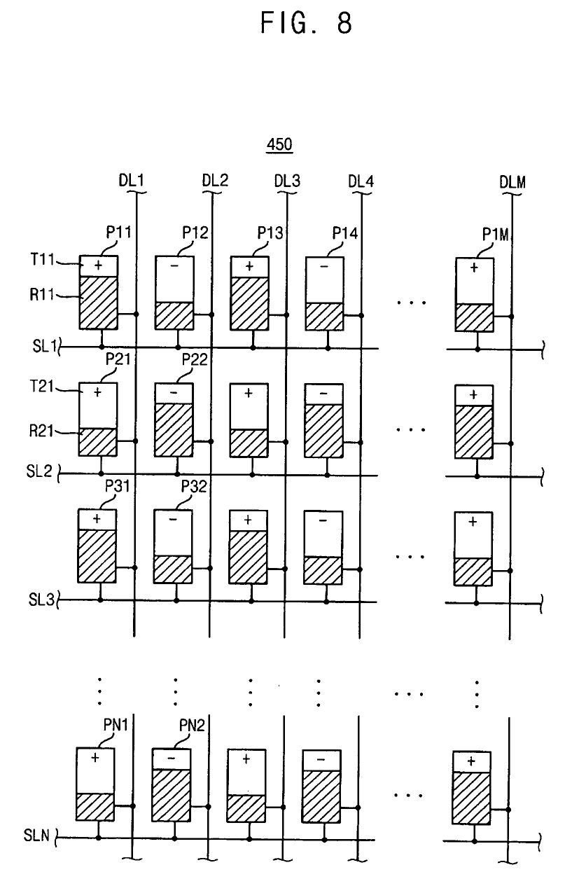

FIG. 7 shows a luminescent characteristic of the liquid crystal display device in FIG. 5 when operating in reflective mode.

Referring to FIGS. 5 and 7, a size ratio (R11:T11) between the first reflective area R11 and the first transmission area T11 of the first pixels P11 is different from a size ratio (R12:T12) between the second reflective area R12 and the second transmission area T12 of the second pixel P12 that is adjacent to the first pixel P11 (i.e., R11:T11≠R12:T12). For example, the first reflective area R11 is greater than the second reflective area R12.

Therefore, the amount of light reflected from the first pixel P11 is greater than the amount of light reflected from the second pixel P12, and the ratio of the reflected amounts of light is proportional to the size ratio between the first and second reflective areas R11 and R12. This way, the luminescent characteristic of the first and second pixels P11 and P12 adjacent to each other along the scan line may visually appear to be operating under the dot inversion method.

Here, a size ratio between the first and second reflective areas R11 and R12 and the first and second transmission areas T11 and T12 is substantially identical to a size ratio between an entire reflective area ER of the array substrate and an entire transmission area ET (i.e., R1+R2:T1+T2=ER:ET).

FIG. 8 is a schematic view illustrating a column inversion scheme of the liquid crystal display device in FIG. 3.

Referring to FIG. 8, pixels P11, P21, . . . , PN1 coupled to a first data line DL1 of the liquid crystal panel 450 are charged to a voltage having a first polarity (e.g., (+)) and pixels P12, P22, . . . , PN2 coupled to a second data line DL2 next to the first data line DL1 are charged to a voltage having a second polarity (e.g., (−)) opposite the first polarity. Similarly, other pixels coupled to the respective data lines of the liquid crystal panel 450 are charged with voltages of alternating polarities, creating column inversion.

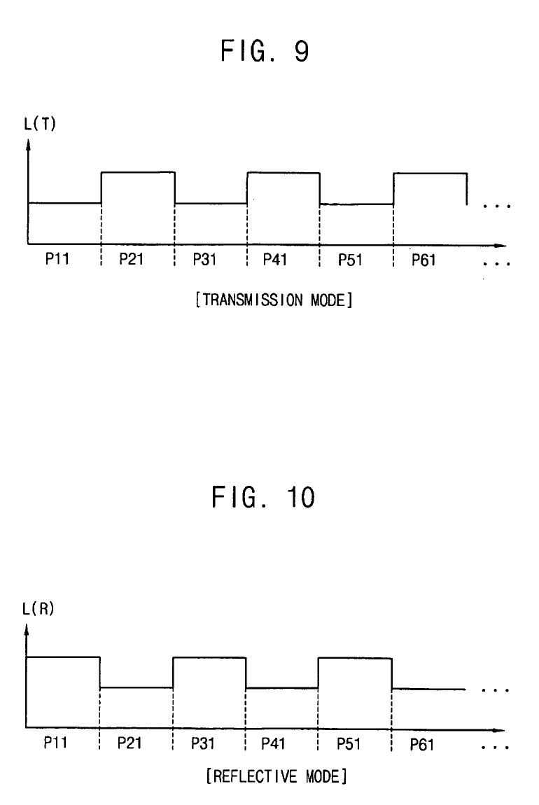

FIG. 9 shows a luminescent characteristic of the liquid crystal display device in FIG. 8 when operating in transmission mode.

Referring to FIGS. 8 and 9, a size ratio (R11:T11) between a first reflective area R11 and a first transmission area T11 of a first pixels P11 is different from a size ratio (R21:T21) between a second reflective area R21 and a second transmission area T21 of a second pixel P21 that is adjacent to the first pixel P11 in a column direction (i.e., R11:T11≠R21:T21). For example, the first transmission area T11 is smaller than the second transmission area T21.

Therefore, the amount of light transmitted through the first pixel P11 is less than the amount of light transmitted through the second pixel P21. The amounts of light transmitted through the first pixel P11 and the second pixel P21 are proportional to the size ratio (T11:T21) between the first and second transmission areas T11 and T21. The luminescent characteristic of the first and second pixels P11 and P21 adjacent to each other along the data line may visually appear to be operating under the dot inversion.

FIG. 10 shows a luminescent characteristic of the liquid crystal display device in FIG. 8 when operating in reflective mode.

Referring to FIGS. 8 and 10, the size ratio (R11:T11) between the first reflective area R11 and the first transmission area T11 of the first pixel P11 is different from the size ratio (R21:T21) between the second reflective area R21 and the second transmission area T21 of the second pixel P21 that is adjacent to the first pixel P11 in the column direction (i.e., R11:T11≠R21:T21). For example, the first reflective area R11 is greater than the second reflective area R21.

Therefore, an amount of light reflected by the first pixel P11 is greater than the amount of light reflected by the second pixel P21. The amounts of light reflected by the first pixel P11 and the second pixel P21 are proportional to a size ratio (R11:R21) between the first and second reflective areas R11 and R21. Thus, the luminescent characteristic of the first and second pixels P11 and P21 adjacent to each other along the data line may visually appear to be operating under the dot inversion.

A size ratio (R11+R21:T11+T21) between the sum of the first and second reflective areas R11 and R21 and the sum of the first and second transmission areas T11 and T21 is equal to a size ratio (ER:ET) between an entire reflective area ER of the array substrate and an entire transmission area ET (i.e., R11+R21:T11+T21=ER:ET).

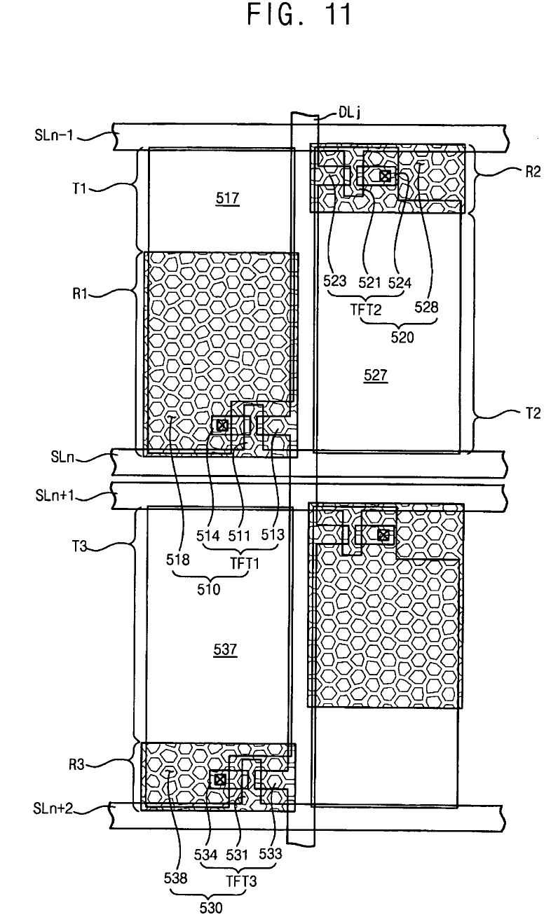

FIG. 11 is a plan view illustrating a part of an array substrate according to another exemplary embodiment of the present invention.

Referring to FIG. 11, the array substrate includes N×M pixels defined by 2N scan lines and M/2 data lines. The array substrate includes a first pixel 510, a second pixel 520 aligned with the first pixel 510 in a first direction and a third pixel 530 aligned with the second pixel 520 in a second direction.

The first pixel 510 includes a first switching element TFT1, a first storage capacitor (not shown) and a first pixel electrode 517 that is electrically coupled to one end of a first liquid crystal capacitor (not shown). The first switching element TFT1 includes a first gate electrode 511 coupled to a first scan line SLn extending in a first direction, a first source electrode 513 coupled to a first data line DLj and a first drain electrode coupled to the first pixel electrode 517.

The first storage capacitor (not shown) has a first end electrically coupled to a first electrode (not shown) formed together with the first gate electrode 511 on a same layer and a second end electrically coupled to the first pixel electrode 517. The first storage capacitor may have a first electrode formed along an edge portion of the first pixel 517 to increase the aperture ratio. The storage capacitors in the respective pixels are electrically coupled to one another.

The first pixel electrode 517 has a first reflective area R1 where a reflective plate 518 for reflecting a first light is positioned and a first transmission area T1 for transmitting a second light. The “first light” and the “second light” are defined above.

The second pixel 520 is adjacent to the first pixel in the first direction. The second pixel 520 includes a second switching element TFT2, a second storage capacitor (not shown) and a second pixel electrode 527 that is electrically coupled to one end of a second liquid crystal capacitor (not shown). The second switching element TFT2 has a second gate electrode 521 coupled to a scan line SLn-1 that is preceding the first scan line SLn, a second source electrode 523 coupled to the first line DLj and a second drain electrode 524 coupled to the second pixel electrode 527. The second storage capacitor (not shown) has a first end electrically coupled to a first electrode (not shown) formed together with the second gate electrode 521 on the same layer and a second end electrically coupled to the second pixel electrode 527. The second pixel electrode 527 has a second reflective area R2 where a reflective plate 528 for reflecting the first light is positioned and a second transmission area T2 for transmitting the second light.

A size ratio (R1:T1) between the first reflective area R1 and the first transmission area T1 of the first pixel unit 510 is different from a size ratio (R2:T2) between the second reflective area R2 and the second transmission area T2 of the second pixel unit 520 (i.e., R1:T1≠R2:T2). However, a size ratio (R1+R2:T1+T2) between the sum of the first and second reflective areas R1 and R2 and the sum of the first and second transmission areas T1 and T2 is equal to a size ratio (ER:ET) between an entire reflective area ER of the array substrate and an entire transmission area ET (i.e., R1+R2:T1+T2=ER:ET)

The third pixel 530 is adjacent to the first pixel 510 in a second direction. The third pixel 130 includes a third switching element TFT3, a third storage capacitor (not shown) and a third pixel electrode 537 that is electrically coupled to one end of a third liquid crystal capacitor (not shown).

The third switching element TFT3 has a third gate electrode 531 coupled to a second scan line SLn+2, a third source electrode 533 coupled to the first data line DLj and a third drain electrode 534 coupled to the third pixel electrode 537. The third storage capacitor (not shown) has a first end electrically coupled to a first electrode (not shown) formed together with the third gate electrode 531 on a same layer and a second end electrically coupled to the third pixel electrode 537. The third pixel electrode 537 has a third reflective area R3 where a reflective plate 538 for reflecting the first light is formed and a third transmission area T3 for transmitting the second light.

The size ratio (R1:T1) between the first reflective area R1 and the first transmission area T1 of the first pixel unit 510 is different from a size ratio R3:T3 between the third reflective area R3 and the third transmission area T3 (i.e., R1:T1≠R3:T3). However, a size ratio (R1+R3:T1+T3) between the sum of the first and third reflective areas R1 and R3 and the sum of the first and third transmission areas T1 and T3 is equal to a size ratio (ER:ET) between the entire reflective area ER of the array substrate and the entire transmission area ET (i.e., R1+R3:T1+T3=ER:ET).

Additionally, a size ratio (R1+R2+R3:T1+T2+T3) between over the sum of the first through third reflective areas R1 to R3 and the sum of the first through third transmission areas T1 to T3 is equal to a size ratio ER:ET between the entire reflective area ER of the array substrate and the entire transmission area ET (i.e., R1+R2+R3:T1+T2+T3=ER:ET).

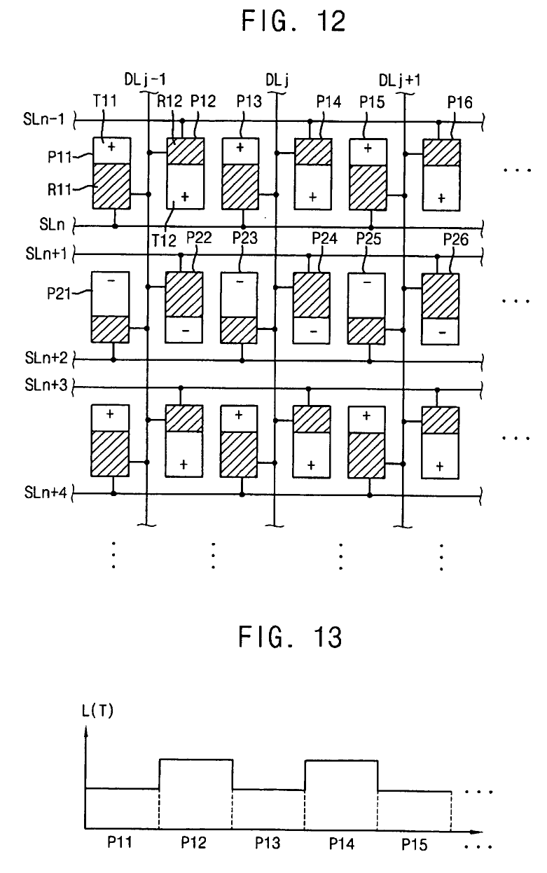

FIG. 12 is a schematic view illustrating a line inversion scheme adopted for a liquid crystal display device having the array substrate of FIG. 11, and FIG. 13 shows a luminescent characteristic of the liquid crystal display device in FIG. 12 when operating in a transmission mode.

Referring to FIGS. 12 and 13, pixels P11, P12, . . . P1M coupled to (n−1)-th and n-th scan lines SLn−1 and SLn are charged to voltages having a first polarity (e.g., positive polarity (+)). Pixels P21, P22, . . . P2M coupled to (n+1)-th and (n+2)-th scan lines SLn+1 and SLn+2 are charged to voltages having a second polarity (e.g., negative polarity (−)).

A size ratio (R11:T1) between a first reflective area R11 and a first transmission area T11 of a first pixel P11 is different from a size ratio (R12:T12) between a second reflective area R12 and a second transmission area T12 of a second pixel P12 that is adjacent to the first pixel P11 in a row direction (i.e., R11:T11≠R12:T12). For example, the first transmission area T11 is smaller than the second transmission area T12 so that an amount of light transmitting the first pixel P11 is relatively smaller than an amount of light transmitting the second pixel P12. Thus, the luminescent characteristic of the first and the second pixels P11 and P12 adjacent to each other may visually appear to be operating under the dot inversion method.

The luminescent characteristic in FIG. 13 shows a visual effect of operating under the dot inversion method when the liquid crystal display device operates in the transmission mode. Also, the visual effect of operating under the dot inversion method may be achieved when the liquid crystal display device operates in the reflective mode.

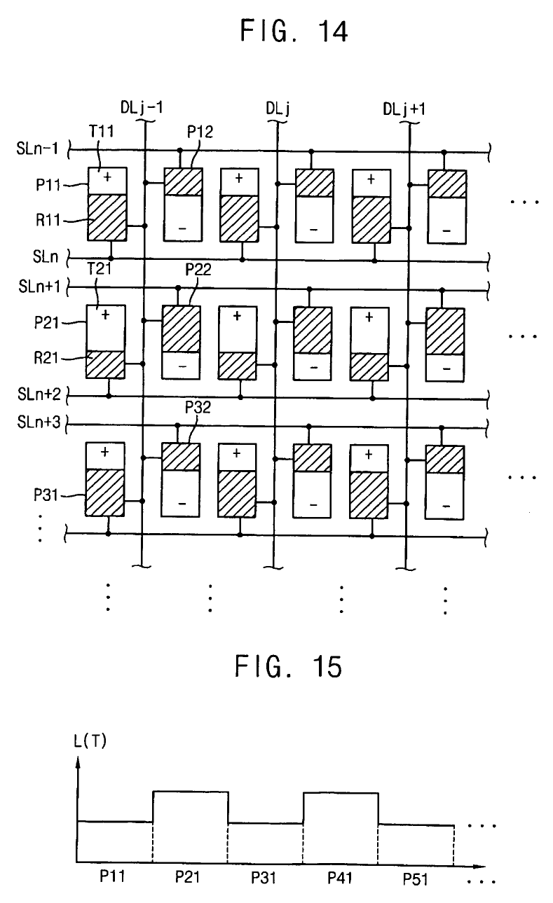

FIG. 14 is a schematic view illustrating a column inversion scheme adopted for the liquid crystal display device having the array substrate of FIG. 11, and FIG. 15 shows a luminescent characteristic of the liquid crystal display device in FIG. 14 when operating in the transmission mode.

Referring to FIGS. 14 and 15, a size ratio (R11:T11) between a first reflective area R11 and a first transmission area T11 of a first pixel P11 is different from a size ratio (R21:T21) between a second reflective area R21 and a second transmission area T21 of a second pixel P21 that is adjacent to the first pixel P11 in a column direction. For example, the first transmission area T11 is smaller than the second transmission area T21 so that the amount of light transmitted through the first pixel P11 is less than the amount of light transmitted through the second pixel P21. Therefore, the luminescent characteristic of the first and second pixels P11 and P21 adjacent to each other along the data line may visually appear to be operating under the dot inversion method.

The luminescent characteristic in FIG. 15 shows the visual effect as performing the dot inversion method when the liquid crystal display device operates in the transmission mode. Also, substantially the same visual effect as performing the dot inversion method may be achieved when the liquid crystal display device operates in the reflective mode. Here, a size ratio (R11+R21:T11+T21) between the sum of the first and second reflective areas R11 and R21 and the sum of the first and second transmission areas T1 and T2 is equal to a size ratio (ER:ET) between the entire reflective area ER of the array substrate and the entire transmission area ET (i.e., R11+R21:T11+T21=ER:ET).

According to exemplary embodiments of the present invention, first and second pixels neighboring each other have different size ratios between the reflective area and the transmission area. In addition, the size ratio between the reflective areas of the first and second pixels and the transmission areas of the first and second pixels is equal to the size ratio between the total reflective area and the total transmission area of the array substrate.

Therefore, when a line inversion method is adopted for the liquid crystal display device, the liquid crystal display device may achieve the visual effect of operating under the dot inversion method and have reduced flicker of a horizontal stripe. Additionally, when a column inversion method is adopted for the liquid crystal display device, the liquid crystal display device may achieve the visual effect as operating under the dot inversion method and have reduced flicker of a vertical stripe.

Having thus described exemplary embodiments of the present invention, it is to be understood that the invention defined by the appended claims is not to be limited by particular details set forth in the above description as many apparent variations thereof are possible without departing from the spirit or scope thereof as hereinafter claimed.

What is claimed is:

1. An array substrate having scan lines extending in a first direction, data lines extending in a second direction that is substantially perpendicular to the first direction and pixel units defined by the scan lines and data lines, each of the pixel units having a reflective area and a transmission area, the array substrate comprising:
a first pixel unit having a first reflective area for reflecting a first light and a first transmission area for transmitting a second light; and
a second pixel unit adjacent to the first pixel unit, having a second reflective area for reflecting the first light and a second transmission area for transmitting the second light, wherein the second reflective area has a size different from a size of the first reflective area and the second transmission area has a size different from a size of the first transmission area.

2. The array substrate of claim 1, wherein the first pixel unit and the second pixel unit have a substantially same size.

3. The array substrate of claim 1, wherein a size ratio between the first reflective area and the first transmission area is different from a size ratio between the second reflective area and the second transmission area.

4. The array substrate of claim 1, wherein a size ratio between an entire reflective area of the array substrate and an entire transmission area is substantially identical to a size ratio between the sum of the first and second reflective areas and the sum of the first and second transmission areas.

5. The array substrate of claim 4, wherein the first pixel unit further includes a first switching element coupled to a first scan line and a first data line, and the first switching element is formed in the first reflective area.

6. The array substrate of claim 5, wherein the second pixel unit further includes a second switching element coupled to the first scan line and a second data line adjacent to the first data line, and the second switching element is formed in the second reflective area.

7. The array substrate of claim 5, wherein the second pixel unit further includes a second switching element coupled to a second scan line adjacent to the first scan line and the first data line, and the second switching element is formed in the second reflective area.

8. The array substrate of claim 2, wherein the first pixel unit further includes a second switching element coupled to a first scan line and a first data line, the second pixel unit further includes a second switching element coupled to a second scan line and the first data line, and wherein the first and second switching elements are formed in the first and second reflective areas, respectively.

9. The array substrate of claim 8, wherein the second scan line precedes the first scan line.

10. The array substrate of claim 5, further comprising:
a third pixel unit configured to align with the first pixel unit, having a third reflective area for reflecting the first light and a third transmission area for transmitting the second light, wherein a size of the third reflective area is different from a size of the first reflective area and a size of the third transmission area is different from a size of the first transmission area.

11. The array substrate of claim 10, wherein the third pixel unit further includes a third switching element coupled to a third scan line and the first data line, and the third switching element is formed in the third reflective area.

12. The array substrate of claim 11, wherein the third scan line is the scan line next to the first scan line.

13. The array substrate of claim 11, wherein the third scan line is the scan line preceding the first scan line.

14. A display panel comprising:
a first substrate including a first pixel unit and a second pixel unit adjacent to the first pixel unit, the first and second pixel units having first and second reflective areas and first and second transmission areas, respectively, wherein the second reflective area has a size different from a size of the first reflective area and the second transmission area has a size different from a size of the first transmission area.
a liquid crystal layer; and
a second substrate combined with the first substrate to receive the liquid crystal layer.

15. The display panel of claim 14, wherein the second substrate includes a color filter in the respective pixel units.

16. The display panel of claim 14, wherein a first cell gap of the liquid crystal layer in the first reflective area is different from a second cell gap of the liquid crystal layer in the first transmission area.

17. The display panel of claim 16, wherein the first cell gap is smaller than the second cell gap.

18. The display panel of claim 14, wherein a third cell gap of the liquid crystal layer in the second reflective area is different from a fourth cell gap of the liquid crystal layer in the second transmission area.

19. The display panel of claim 18, wherein the third cell gap is smaller than the fourth cell gap.

20. A display device comprising:
a display unit having a plurality of pixel units, each of which has a reflective area and a transmission area, wherein two adjacent pixels are different in a size ratio between the reflective area and the transmission area and, wherein a size ratio between the sum of the reflective areas of the adjacent two pixels and the sum of the transmission areas is substantially identical to a size ratio between an entire reflective area of the display unit and an entire transmission area; and
a driver unit configured to provide the display unit with a driving signal for driving the pixels.

21. The display device of claim 20, wherein the display unit further includes a first pixel unit, a second pixel unit aligned with the first pixel unit in a first direction and a third pixel unit aligned with the first pixel unit in a second direction.

22. The display device of claim 21, wherein when the driver provides the first and second pixel units with a data signal having a first polarity and provides the third pixel unit with the data signal having a second polarity, an amount of a light exiting the first pixel unit is greater than an amount of light exiting the second pixel unit.

23. The display device of claim 21, wherein when the driver provides the first and second pixel units with a data signal having a first polarity and provides the third pixel unit with the data signal having a second polarity, an amount of a light exiting the first pixel unit is smaller than an amount of light exiting the second pixel unit.

24. The display device of claim 21, wherein when the driver provides the first and third pixel units with a data signal having a first polarity and provides the second pixel unit with the data signal having a second polarity, an amount of a light exiting the first pixel unit is greater than an amount of light exiting the third pixel unit.

25. The display device of claim 21, wherein when the driver provides the first and third pixel units with a data signal having a first polarity and provides the second pixel unit with the data signal having a second polarity, an amount of a light exiting the first pixel unit is smaller than an amount of light exiting the third pixel unit.
